(19) United States
(12) Patent Application Publication
(10) Pub. No.: US 2022/0198641 A1
(43) Pub. Date: Jun. 23, 2022

(54) TREE FALL MANAGEMENT

(71) Applicant: International Business Machines Corporation, Armonk, NY (US)

(72) Inventors: Michael S. Gordon, Yorktown Heights, NY (US); Evelyn Duesterwald, Millwood, NY (US); Valentina Salapura, Sunnyvale, CA (US); Komminist Weldemariam, Ottawa (CA)

(21) Appl. No.: 17/132,063

(22) Filed: Dec. 23, 2020

(51) Int. Cl. G06T 7/00; G06Q 50/16; G06F 16/29; G06F 16/587; G06N 3/04; G06N 3/08; G06F 30/27; G06K 9/00; G06K 9/62; G01W 1/10; G01C 11/04

(52) U.S. Cl. CPC G06T 7/0002; G06Q 50/163; G06F 16/29; G06F 16/587; G06N 3/04; G06N 3/08; G06Q 50/26; G06K 9/00624; G06K 9/6267; G06K 9/6256; G01W 1/10; G01C 11/04; G06F 30/27

(57) ABSTRACT

An approach to tree fall risk management. This approach may identify a tree in a given location. Historical data associated with the geographic location may be received in the approach. A current condition or status of the tree may be identified by the approach. The approach may analyze the foreseeable weather forecast or weather conditions in conjunction with the status of the identified tree. The approach may generate a risk score based on the information received and analyzed. The risk score may indicate the tree is likely to fall and cause damage. The approach may result in tree fall mitigation action can be generated based on the risk score.

### BACKGROUND OF THE INVENTION

The present invention relates generally to tree fall and foliage management and more specifically, to generating mitigation actions for potential tree falls.

Falling trees and foliage cause billions of dollars in damage every year to property and injury or death to persons and animals. In many cases falling trees and branches can cause downed powerlines, resulting in disruptions to commerce and prevent safety services from safely traversing roadways. Severe weather is one of the main factors which cause trees and branches to fall and cause damage. Many trees are trimmed to prevent potential damage due to severe weather, but in some cases unexpected factors can cause a tree to fall resulting in damage to property and injury or death to persons or animals.

### SUMMARY

Embodiments of the present disclosure include a computer-implemented method and a computer-system for generating a tree fall mitigation action. The embodiments may include the following identify a tree at a geographic location, based on an image. Receiving historical data for the geographic location. Identifying one or more conditions for the tree. Identifying a weather risk indicator for the geographic location. Generating a tree fall risk score, based on the historical data, one or more tree conditions, and the weather risk indicator. Additionally, embodiments may include, generating a tree fall mitigation action, if the tree fall risk score is above a threshold.

The above summary is not intended to describe each illustrated embodiment of every implementation of the present disclosure.

### BRIEF DESCRIPTION OF THE DRAWINGS

FIG. 1 is a functional block diagram generally depicting a tree fall risk management environment, in accordance with an embodiment of the present invention.

FIG. 2 is a functional block diagram depicting a tree fall management engine, in accordance with an embodiment of the present invention.

FIG. 3 is a flowchart depicting operational steps of a method for generating a tree fall mitigation action, in accordance with an embodiment of the present invention.

FIG. 4 is a functional block diagram of an exemplary computing system within a tree fall management environment, suitable for generating a tree fall mitigation action, in accordance with an embodiment of the present invention.

FIG. 5 is a diagram depicting a cloud computing environment, in accordance with an embodiment of the present invention.

FIG. 6 is a functional block diagram depicting abstraction model layers, in accordance with an embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The embodiments depicted and described herein recognize the need for predicting risks and potential damage associated with falling trees and branches and generating tree fall amelioration actions. In an embodiment, a tree may be identified in a specific geographic location. Historical data relating to weather and soil conditions for the location may be received. A condition of the identified tree may be recognized. The predicted weather for a time frame can be determined and a tree fall risk score can be generated for the predicted weather, factoring in the condition of the identified tree and the historical data for the location. If the tree fall risk score is above a predetermined threshold, a tree fall amelioration action can be generated.

In some embodiments, the tree may be identified with an individual image from a camera or a video recording from a video camera (e.g. webcam, smart glasses, cellular telephone, tablet, etc.). The tree can be identified utilizing a pixel-level classifier. The pixel level classifier can be an artificial intelligence model based on a deep neural network (“DNN”) (e.g. a convolutional neural network). The pixel level classifier can identify one or more trees within the image or video recording.

In some embodiments, a tree fall risk score can be generated by a machine learning model, where the machine learning model is a DNN. Multiple factors may be feed into the DNN, including the historical data for the location, the condition of the identified tree, predicted weather conditions, and real-time data feeds from sensors located proximally to the identified tree. Further, the tree fall risk score can be generated for one or more trees within the area based on the proximity of other trees to the identified tree.

Additional embodiments may further include one or more sensors capable of reporting a condition associated with the identified tree. These sensors may include soil moisture sensors, accelerometers, thermometers, anemometers, seismographs, etc.

Embodiments may include a physics simulation engine capable of predicting potential damage caused by one or more falling trees, based on the weather predictions for the location. The physics simulation engine may be a machine learning model trained with tree images and severe weather data and resulting outcomes. Historical location data may include information of permanent and semi-permanent property located near the identified tree. Additionally, in embodiments where a real-time image feed is available, a pixel level classifier may identify transient objects which can be factored into the physics simulation engine and predict potential damage.

In describing embodiments in detail with reference to the figures, it should be noted that references in the specification to “an embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, describing a particular feature, structure or characteristic in connection with an embodiment, one skilled in the art has the knowledge to affect such feature, structure or characteristic in connection with other embodiments whether or not explicitly described.

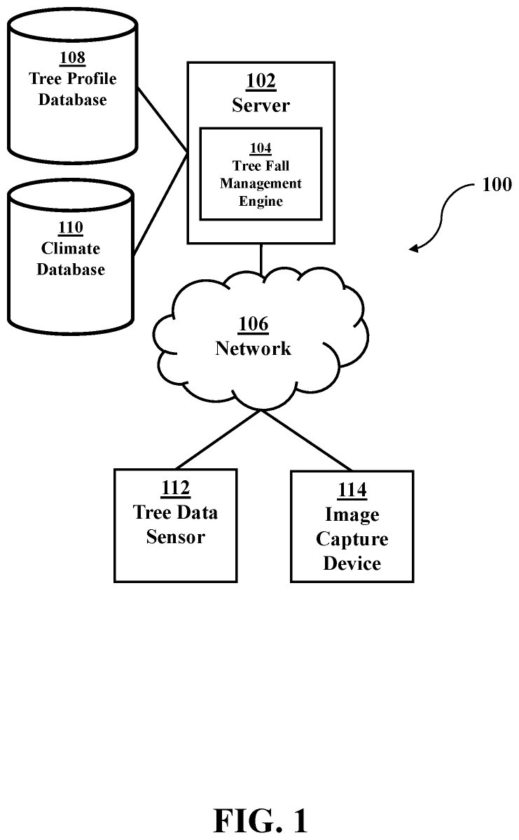

FIG. 1 is a functional block diagram depicting, generally, a tree fall risk management environment 100. Tree fall risk management environment 100 comprises a tree fall management engine 104 operational on a server computer 102, tree profile database 108 and climate database 110 stored on server computer 102, tree data sensor 112, and network 106 supporting communications between the server computer 102, tree data sensor 112 and additional computing devices (not shown).

Server computer 102 can be a standalone computing device, management server, a web server, a mobile computing device, or any other electronic device or computing system capable of receiving, sending, and processing data. In other embodiments, server computer 102 can represent a server computing system utilizing multiple computers as a server system. In another embodiment, server computer 102 can be a laptop computer, a tablet computer, a netbook computer, a personal computer, a desktop computer, or any programmable electronic device capable of communicating with other computing devices (not depicted) within tree fall risk management environment 100 via network 106.

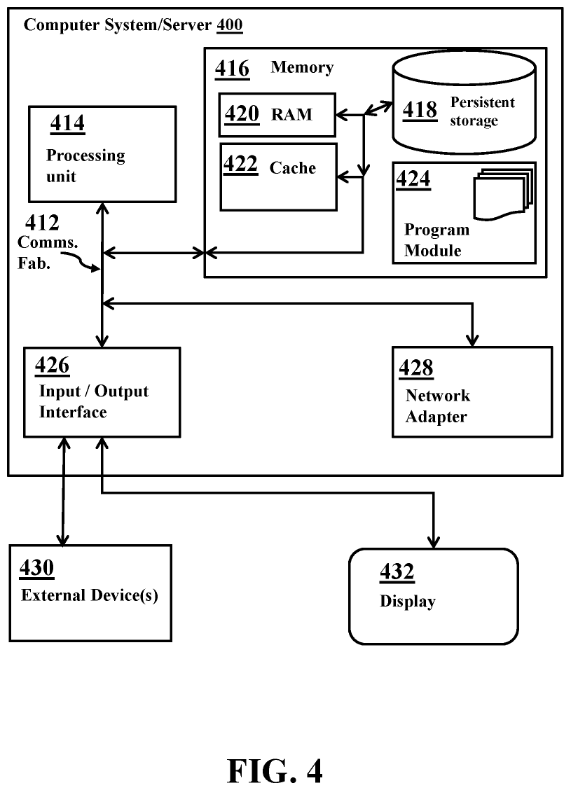

In another embodiment, server computer 102 represents a computing system utilizing clustered computers and components (e.g., database server computers, application server computers, etc.) that act as a single pool of seamless resources when accessed within tree fall risk management environment 100. Server computer 102 can include internal and external hardware components, as depicted and described in further detail with respect to FIG. 4.

Tree Fall Management Engine 104 can be a module for receiving data inputs, and generating tree fall amelioration actions with machine learning models and deep neural networks. It should be noted, in some embodiments there can be multiple instances of tree fall management engine 104 operating on multiple target servers or within a server center. Some embodiments can allow for the user to review the tree fall amelioration action and verify if it is correct, prior to executing the tree fall amelioration action, via a notification (e.g., within a smart phone application, e-mail, web-portal, etc.). Additionally, embodiments of the invention can be configured using historical data and effectiveness of past tree fall amelioration actions to ensure the generation of efficient and cost-effective and proper amelioration actions.

Network 106 can be, for example, a local area network (LAN), a wide area network (WAN) such as the Internet, or a combination of the two, and can include wired, wireless, or fiber optic connections. In general, network 106 can be any combination of connections and protocols that will support communications between server computer 102, tree data sensor 112, image capture device 114 and other computing devices (not depicted).

Tree profile database 108 can be a database that may contain data relating to one or more trees. The data can include information associated with a tree including species, geographic location, age of the tree, topology of the landscape surrounding the tree, angle of the tree's trunk relative to the ground or the branches relative to the ground, proximity of the tree or branches to property, power lines, livestock or parked vehicles, and soil composition. Additional information can include if the tree is damaged due to broken branches or tree limbs, rot, pest infestation, or disease. In some embodiments, tree profile database 108 can contain information relating to the expected tensile strength of the wood for the specific tree and trees surrounding the tree. In various embodiments, information relating to the age, diameter, and protected status can be contained in tree profile database 108. Further, if a tree has protected status information (e.g. a permit is required for trimming or falling the tree due to the tree's size, species, etc.) contact information associated with the protection entity (e.g. a local/state/federal government department), can be contained in tree profile database 108.

Climate database 110 can be a database that contains historical data related to weather for the geographic area associated with a tree. For example, the database can contain precipitation amount, wind speed, temperatures, flooding information, drought information, prevailing wind direction and sunlight or ultraviolet light exposure. Additional information may relate to pest or insect infestations associated with trees or soil in the geographic area. Tree data sensor 112 can be a sensor capable of recording environmental conditions and taking real time readings of environmental conditions. Tree data sensor 112 can also be capable of sending the recorded and real time readings to tree fall management engine 104. It should be noted, tree data sensor 112 can be associated with one or more trees in a given area. Tree data sensor 112 can be configured with data relating to the proximity (distance, orientation to tree, etc.) of a tree or trees of interest. Examples of environmental readings can include temperature, precipitation amount, soil moisture content, wind speed, seismic activity, tree motion, tree limb angles/growth, tree disease, etc. . . . Further, the readings and recordings from tree data sensor 112 can be stored in climate database 110 and tree profile database 108. While one tree data sensor is shown in FIG. 1, this is for illustration purposes only, as multiple tree data sensors (i.e. 1, 2, n . . . n+1) capable of reading one or more environmental conditions may be present in an embodiment.

Image capture device 114 can be a device capable of capturing a still image or recording of a tree. Image capture device can be a camera, web camera, satellite with image recording capabilities, virtual reality portal, augmented reality glasses, etc. The image can be a still print image, digital image, real-time data feed of a location, satellite image, or the like. Further, in an embodiment, image capture device may be stationary or mobile, capable of capturing images of a tree or trees in a given location at multiple angles. While one image capture device is shown in FIG. 1, this is for illustration purposes only, as multiple image capture devices may be present in an embodiment.

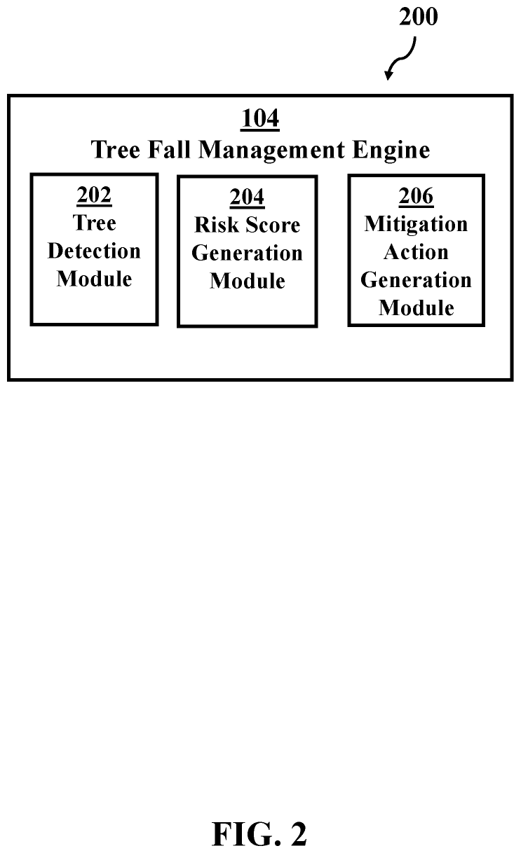

FIG. 2 is a functional block diagram 200 depicting tree fall management engine 104. Operational on tree fall management engine 104 is tree detection module 202, risk score generation module 204, and mitigation action generation module 206.

Tree detection module 202 can be a computer module that can identify a tree from an image. In some embodiments, tree detection module 202 can detect one or more trees and other objects, property, or structures from one or more images received from image capture device 114. For example, tree detection module 202 may receive an image from a satellite with geographic information. Tree detection module 202 may use a pixel classifier to determine an individual tree and objects or structures around the tree. In some embodiments, the pixel classifier can be a deep neural network (e.g. convolutional, long-short term memory, etc.) trained on body of labelled satellite photos of trees. In some embodiments, tree detection module may receive live images from one or more video cameras (e.g., surveillance cameras, webcams, smart phones) and identify one or more trees from the received live images using an image classification model using pixel classification. Additionally, tree detection module 202 can identify permanent objects within an image such as structures (e.g. residences, outbuildings, barns, livestock corrals, garages, etc.) and/or semi-permanent objects, (e.g. vehicles, tractors, trailers, mobile homes, sheds etc.).

Risk score generation module 204 is a computer module that can generate a risk associated with a tree falling and/or tree limb falling based on identification of one or more trees and an associated environmental factor. In an embodiment, risk score generation module 204 can receive an identified tree from tree detection module 202. Risk score generation module 204 can retrieve data related to the identified tree from tree profile database 108 and/or climate database 110. Additionally, risk score generation module 204 can receive current environmental conditions from tree data sensor 112. Further, in some embodiments, risk score generation module may be capable of predicting future weather conditions (e.g., temperature, precipitation, wind, flooding, ice, drought, etc.) using a machine learning model. In various embodiments, risk score generation module 204 can receive or obtain weather forecasts from various government and commercial sources (e.g. The National Weather Service, The National Oceanic and Atmospheric Administration, The Weather Channel®, local news channels, etc.) Additionally, risk score generation module 204 can have physics simulation modelling capabilities and predict the fall path of a tree or tree limb, based on factors associated with the current and predicted environmental conditions. Finally, risk score generation model 204 can generate a risk score based on a multitude of factors using a deep neural network trained with the above-mentioned data.

In an example, tree data sensor 112 may be a soil moisture sensor. Tree data sensor 112 may be associated with one or more identified trees in a known location. Risk score generation module 204 may receive or retrieve data from local climate database 110 relating to the most recent weather for the area where the identified trees are located, and data related to the one or more identified trees from tree data sensor 112. Additionally, the weather for the location can be predicted for the immediate future (e.g. current time to seven days from the current time). In this example, there has been heavy rainfall in the location (reported by local climate database) and the soil moisture sensor is reading very saturated soil. Risk score generation module 204 retrieves data from tree data sensor 112 reports the identified tree has the following conditions of a lean and root disease. Predicted weather from a weather model is generated or received at risk score generation module 204. In the current example, there will be sustained high speed winds and heavy precipitation. The information is factored into the physics simulation module and results in a risk score where the physics model predicts the possibility of the tree falling due to the factors received by risk score generation module 204. Further, the physics model can determine the path which a tree or tree limb may fall and any property or items the tree or tree limb may fall on. In the immediate example, a risk score can be generated depending on the chance the tree or tree limb will fall and the resulting damage. If the risk score is above a predetermined threshold the risk score can be sent to mitigation action generation module.

In an embodiment, risk score generation module 204 can convert the data it receives from the various sources described above into risk vectors, which are input into a neural network. The neural network can output a risk score. The neural network can be trained with a corpus of tree fall data including weather, species, location, soil composition, foliage on the tree, angle of tree trunk to the ground. Further, in some embodiments, the neural network can be updated and further trained with the data from real-time inputs. Additionally, if real time monitoring sends images, via a data feed, risk score generation module 204 can monitor one or more trees in a location and update the risk score in dynamically. For example, the risk score can be generated continuously, in preset time intervals (e.g., every hour, day, week, etc.) or on identified weather events (forecasted severe weather).

Mitigation action generation module 206 is a computer module that can generate an action which will prevent or mitigate damage caused by a predicted falling tree or tree limb. In some embodiments, mitigation action generation module 206 can receive a risk score from risk score generation module 204. A mitigation action can be sending a notification to a user's computing device (phone, tablet, computer, etc.) via email, text, or pop-up notification, if associated with an application on a smart device. In some embodiments, a notification can be a notification to move a semi-permanent object or personal property (e.g., car, recreational vehicle, boat, bicycle). In other embodiments, the notification can be a prompt to schedule a tree service to cut down the tree or tree limb which is predicted to cause the damage to a structure. In other embodiments, the mitigation action may be a notification to protect the ground surrounding a tree from further saturation.

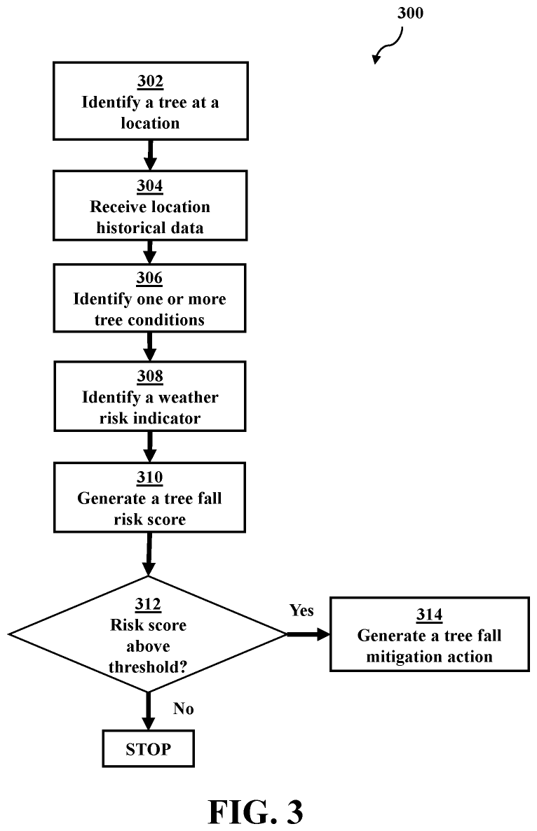

FIG. 3 is a flowchart depicting operational steps of a method for generating a tree fall mitigation action 300. At step 302, identify one or more trees in a given location by tree detection module 202, from an image received by image capture device 114 (as described above with respect to FIG. 2). For example, in an embodiment an image may be received from a user's smart phone or smart glasses. The image can be input into a convolutional neural network. The convolutional neural network can identify a tree from the input image. The image may possess geographic information (e.g. longitude and latitude information), which can be from geospatial positioning system or input from the user. Further, other items may be identified by the convolutional neural network such as vehicles, structures, or personal property.

At step 304, receive historical data associated with the identified tree or trees by risk score generator module 204. Historical data associated with the identified trees can be received from climate database 110 or can be input by a user with a smart device or computing device to risk score generation module 204. In some embodiments, historical data can be received or retrieved from tree profile database by risk score generation module 204.

At step 306, identify one or more conditions associated with the identified tree or trees at risk score generation module 204. In an embodiment, a sensor may identify a condition associated with the tree, such as height of the tree, soil moisture, seismic activity, light exposure, etc. In some embodiments, more than one condition or status can be identified by a sensor or can be input into by a user. Conditions input by a user could include, disease, pest infestation, rot, damage to tree limbs, erosion surrounding roots, etc.

At step 308, identify a weather risk indicator with risk score generation module 204. In some embodiments, a weather prediction model can predict weather multiple days in advance (e.g. from the current time up to seven days out). Additionally, a weather prediction model can forecast severe weather. In some embodiments, only severe weather will be identified by risk score generation module 204 (e.g., ice storm, hurricane, tornado, sandstorm, heavy rain or snow, etc.).

At step 310, generate a tree fall risk score with risk score generation module 204. In some embodiments, the factors identified above can be converted into risk vectors and input into a neural network to generate a risk score. In other embodiments, the risk vectors can be input into a physics model, where the identified tree and surrounding objects are simulated and a prediction for how likely it is a tree will fall or a tree limb will fall. Additionally, in some embodiments, the fall path of the tree or tree limb can be predicted and whether or not objects in proximity to the fall path will be damaged. Further, in some embodiments, the damage to the surrounding landscape can be predicted due to fall path or potential uprooting of trees (e.g., for golf courses and parks). A tree fall risk score can be the calculation of the likelihood of the identified tree falling, the chance the identified tree will cause damage to property, and/or the amount of damage a tree fall will cause (e.g. dollar value or amount of property damaged).

At step 312, determine if the risk score is above a threshold. In some embodiments, risk score is received by mitigation action generation module 206, where mitigation action generation module determined if the risk score is above a threshold. In another embodiment, risk score generation module 204 determines if the risk score is above a threshold before sending the risk score to mitigation action generation module 206. In either embodiment, if the risk score is below a threshold the process ends. If the risk score is above a threshold, the process continues.

In some embodiments, the threshold can be static or dynamic. If it is a dynamic threshold, multiple factors can determine the threshold, including time of year, geographic location, climate, insurance premiums or deductibles, and objects surrounding the identified tree. In some embodiments, the risk score can be used to update the physics model or neural network used to generate the risk score.

At step 314, generate a tree fall risk mitigation action at mitigation action generation module 206. In some embodiments, a notification can be sent to a user's smart device to move mobile or semi-permanent objects. For example, if risk score generation module predicts a damaged tree limb will fall on a car during an upcoming storm, the notification may inform a user to relocate the car. In another example, if a pop-up shed is in the likely path of a tree falling a notification can be send to a user to relocate or dismantle the shed to prevent damage. In other embodiments, if it is determined a tree fall will likely cause damage to a permanent structure (e.g., home, garage, workshop), mitigation action generation module 206 can schedule a tree service to come and cut down the tree or add supports to the tree. Further, in various embodiments, tree fall risk mitigation action can comprise notification of protection entities for specific trees identified as protected due of the likelihood of damage due from the tree. In addition to notifying the protection entity, mitigation action generation module 206 can generate a permit application for trimming or falling of the tree.

Further, in some embodiments, at step 314, tree fall risk mitigation action can include notification of one or more insurance companies. The insurance company may be identified by a user in a registration process to access the tree fall risk mitigation action via a smart device app or web-portal. The data generated by a physics model and predicted property damage can be transmitted to the insurance company. In some embodiments, tree fall mitigation action notifications and associated actions can be transmitted for premium and liability calculations.

In some embodiments, at step 314, the user may receive a prompt to accept the generated mitigation action or mitigation action generation module 206 can automatically schedule the action to occur if the user has configured the module to pre-accept the actions generated. The user response can be used to update risk score calculation on mitigation action generation module 206 for future tree fall risk mitigation actions and notifications of parties.

FIG. 4 depicts a functional block diagram of an exemplary computer system 400 within tree fall risk management environment 100. Computer system 400 includes communications fabric 412, which provides communications between computer processor(s) 414, memory 416, persistent storage 418, network adaptor 428, and input/output (I/O) interface(s) 426. Communications fabric 412 can be implemented with any architecture designed for passing data and/or control information between processors (such as microprocessors, communications and network processors, etc.), system memory, peripheral devices, and any other hardware components within a system. For example, communications fabric 412 can be implemented with one or more buses.

Computer system 400 includes processing unit 414, cache 422, memory 416, network adaptor 428, input/output (I/O) interface(s) 426 and communications fabric 412. Communications fabric 412 provides communications between cache 422, memory 416, persistent storage 418, network adaptor 428, and input/output (I/O) interface(s) 426. Communications fabric 412 can be implemented with any architecture designed for passing data and/or control information between processors (such as microprocessors, communications and network processors, etc.), system memory, peripheral devices, and any other hardware components within a system. For example, communications fabric 412 can be implemented with one or more buses or a crossbar switch.

Memory 416 and persistent storage 418 are computer readable storage media. In this embodiment, memory 416 includes persistent storage 418, random access memory (RAM) 420, cache 422 and program module 424. In general, memory 416 can include any suitable volatile or non-volatile computer readable storage media. Cache 422 is a fast memory that enhances the performance of processors 414 by holding recently accessed data, and data near recently accessed data, from memory 416. As will be further depicted and described below, memory 416 may include at least one of program module 424 that is configured to carry out the functions of embodiments of the invention.

The program/utility, having at least one program module 424, may be stored in memory 416 by way of example, and not limiting, as well as an operating system, one or more application programs, other program modules, and program data. Each of the operating systems, one or more application programs, other program modules, and program data or some combination thereof, may include an implementation of a networking environment. Program module 424 generally carries out the functions and/or methodologies of embodiments of the invention, as described herein.

Program instructions and data used to practice embodiments of the present invention may be stored in persistent storage 418 and in memory 416 for execution by one or more of the respective processors 414 via cache 422. In an embodiment, persistent storage 418 includes a magnetic hard disk drive. Alternatively, or in addition to a magnetic hard disk drive, persistent storage 418 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 418 may also be removable. For example, a removable hard drive may be used for persistent storage 418. Other examples include optical and magnetic disks, thumb drives, and smart cards that are inserted into a drive for transfer onto another computer readable storage medium that is also part of persistent storage 418.

Network adaptor 428, in these examples, provides for communications with other data processing systems or devices. In these examples, network adaptor 428 includes one or more network interface cards. Network adaptor 428 may provide communications through the use of either or both physical and wireless communications links. Program instructions and data used to practice embodiments of the present invention may be downloaded to persistent storage 418 through network adaptor 428.

I/O interface(s) 426 allows for input and output of data with other devices that may be connected to each computer system. For example, I/O interface 426 may provide a connection to external devices 430 such as a keyboard, keypad, a touch screen, and/or some other suitable input device. External devices 430 can also include portable computer readable storage media such as, for example, thumb drives, portable optical or magnetic disks, and memory cards. Software and data used to practice embodiments of the present invention can be stored on such portable computer readable storage media and can be loaded onto persistent storage 418 via I/O interface(s) 426. I/O interface(s) 426 also connect to display 432.

Display 432 provides a mechanism to display data to a user and may be, for example, a computer monitor or virtual graphical user interface.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality and operation of possible implementations of systems, methods, and computer program products according to various embodiments of the present invention. In this regard, each block in the flowchart or block diagrams may represent a module, segment or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

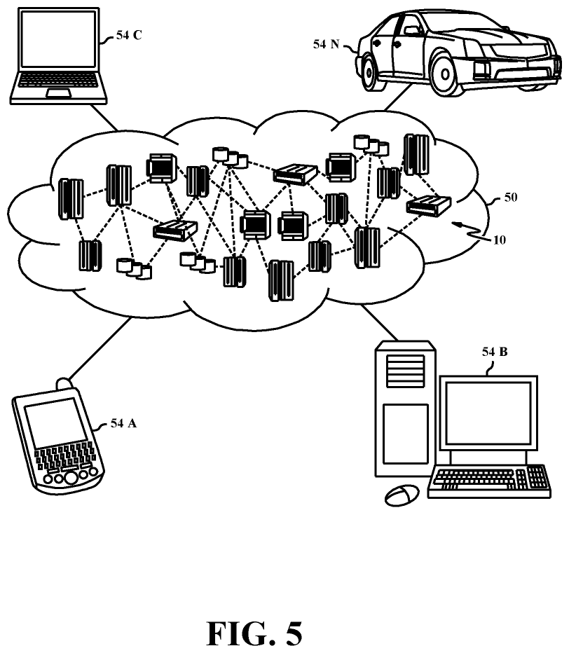

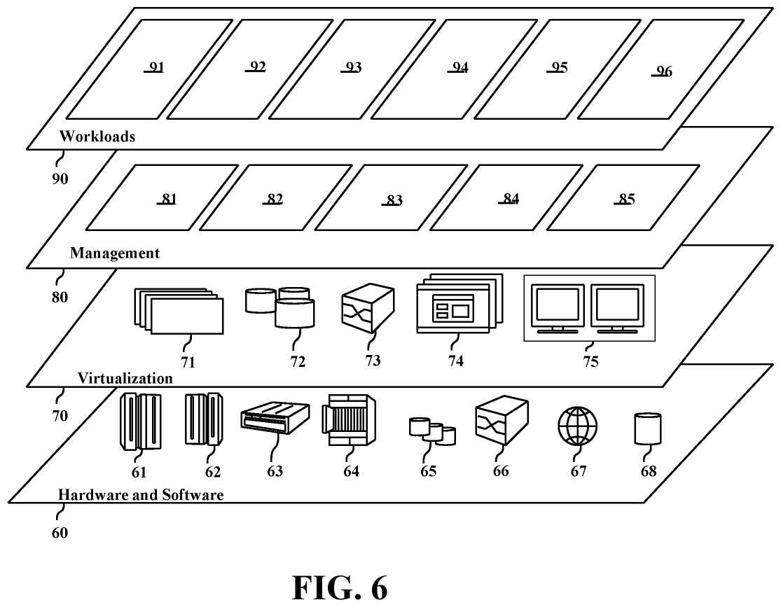

FIG. 5 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

FIG. 6 is a block diagram depicting a set of functional abstraction model layers provided by cloud computing environment 50 depicted in FIG. 5 in accordance with at least one embodiment of the present invention. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and tree fall risk management 96.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for tree fall risk management, the computer-implemented method comprising:
identifying, by one or more processors, a tree at a geographic location, based on an image;
receiving, by the one or more processors, historical data for the geographic location;
identifying, by the one or more processors, one or more conditions for the tree;
identifying, by the one or more processors, a weather risk indicator for the geographic location;
generating, by the one or more processors, a tree fall risk score, based on the historical data, one or more tree conditions, and the weather risk indicator; and
responsive to the tree fall risk score being above a threshold, generating, by the one or more processors, a tree fall mitigation action.

2. The computer-implemented method of claim 1, wherein:
identifying further comprises:
receiving, by the one or more processor, the image with geographic data from an image capture device, wherein the geographic data is from a geospatial positioning system within the image capture device; and
inputting, by the one or more processors, the image into a pixel classifier.

3. The computer-implemented method of claim 2, wherein the pixel classifier is a convolutional neural network trained with a corpus of tree images.

4. The computer-implemented method of claim 1, wherein:
generating a risk score further comprises:
converting, by the one or more processors, the historical data, the one or more tree conditions, and the weather risk indicator into risk vectors; and
inputting, by the one or more processors, the risk vectors into a deep neural network.

5. The computer-implemented method of claim 4, wherein, the deep neural network is trained by a corpus of historical climate data and tree profiles.

6. The computer-implemented method of claim 2, further comprising:
identifying, by the one or more processors, one or more objects from the image received from image capture device, wherein the objects are structures and personal property.

7. The computer-implemented method of claim 6, wherein generating a risk score further comprises:
simulating, by the one or more processors, a tree fall path with a physics simulation model for the identified tree; and
determining, by the one or more processors, damage to the one or more objects.

8. The computer-implemented method of claim 1, wherein generating the tree fall risk score is performed by a cloud-based machine learning model.

9. The computer-implemented method of claim 2, wherein the image capture device is a live-stream feed of the identified tree.

10. The computer-implemented method of claim 2, wherein generated the risk score generation module is updated based on a user configured interval.

11. A computer system for tree fall risk management, the system comprising:
a computer processor;
a computer readable storage media;
computer program instructions;
the computer program instructions being stored on the one or more computer readable storage media for execution by the one or more computer processors; and the computer program instructions including instructions to:
identify a tree at a geographic location, based on an image;
receive historical data for the geographic location;
identify one or more conditions for the tree;
identify a weather risk indicator for the geographic location;
generate a tree fall risk score, based on the historical data, one or more tree conditions, and the weather risk indicator; and
responsive to the tree fall risk score being above a threshold, generate a tree fall mitigation action.

12. The computer system of claim 11, wherein:
identify further comprises instructions to:
receive the image with geographic data from an image capture device, wherein the geographic data is from a geospatial positioning system within the image capture device; and
input the image into a pixel classifier.

13. The computer system of claim 12, wherein the pixel classifier is a convolutional neural network trained with a corpus of tree images.

14. The computer system of claim 11, wherein:
generating a risk score further comprises instructions to:
convert the historical data, the one or more tree conditions, and the weather risk indicator into risk vectors; and
input the risk vectors into a deep neural network.

15. The computer system of claim 14, wherein, the deep neural network is trained by a corpus of historical climate data and tree profiles.

16. The computer system of claim 11, further comprising instructions to:
identify one or more object from the image received from image capture device, wherein the objects are structures and personal property.

17. The computer system of claim 16, wherein generating a risk score further comprises instructions to:
simulate a tree fall path with a physics simulation model for the identified tree; and
determine damage caused due to the tree fall path to the one or more objects.

18. The computer system of claim 11, wherein generating the tree fall risk score is performed by a cloud-based machine learning model.

19. The computer system of claim 12, wherein the image capture device is a live-stream feed of the identified tree.

20. The computer system of claim 12, wherein the generated risk score is updated based on a user configured interval.
